(19) United States
(12) Patent Application Publication
(10) Pub. No.: US 2024/0116199 A1
(43) Pub. Date: Apr. 11, 2024

(54) SYSTEMS AND METHODS FOR SECURING OF FLAGPOLES AND OTHER ELONGATE ITEMS

(71) Applicant: Simple Flag LLC, Manteno, IL (US)

(72) Inventor: Terry Lee Wilson, Manteno, IL (US)

(21) Appl. No.: 18/213,031

(22) Filed: Jun. 22, 2023

Related U.S. Application Data
(60) Provisional application No. 63/414,875, filed on Oct. 10, 2022.

(51) Int. Cl. B25J 18/02

(52) U.S. Cl. CPC B25J 18/025

(57) ABSTRACT

Devices, methods, and systems for securing elongate items including but not limited to a device comprising a grabber portion having a loading zone and a sliding member; an actuator connected to the sliding member; and an extension portion comprising a pole; where the sliding member is biased toward the loading zone in an unactuated state, and the actuator is configured to move the sliding member so that the loading zone is open to receive an elongate item while the sliding member is in an actuated state.

### CROSS REFERENCE TO RELATED APPLICATIONS

This application claims the benefit of U.S. Provisional Patent Application No. 63/414,875, filed Oct. 10, 2022.

### FIELD OF THE INVENTION

Embodiments of the present disclosure relate generally to portable devices for securing, installing, or mounting flagpoles or other elongate items to buildings or other structures for display. The portable devices of this disclosure are also suited for removal of items, holding items in place, or assisting in the completion of a task. One embodiment of this disclosure relates to devices and methods for the efficient installation of flagpoles within a flagpole holder or bracket mounted to a building or other structure.

### BACKGROUND OF THE INVENTION

Flags of various sizes are customarily flown from a pole. Frequently, the poles utilized to hold such flags are attached to buildings used in commerce, government, or downtown areas. Some flagpoles are permanently affixed to buildings. In this case, an individual seeking to display a flag would run the flag across a line attached to an eyelet at the end of the pole and unfurl the flag by movement of the line. However, most flagpoles are temporarily installed on buildings or utility poles via a mounted pole holder or bracket. Such holders or brackets are usually made of a durable material, such as aluminum, stainless steel, cast iron, or even certain plastics. The holders or brackets generally comprise a mounting plate for attachment to a surface and a holder (or bracket) portion. The holder portion may simply be a tubular member that is pivotally attached to the mounting plate, or it is often a fixed brace that allows a tubular member within. Since flags and other decorations must hang from a height sufficient to prevent damage or soiling by animals, pedestrians, and children, the mounting plate is usually attached to a structure between 5 feet and 30 feet from the ground. The height of the flagpole holders or brackets from the ground can cause problems when deploying flags or other items.

A need exists for an apparatus, system, and method for deploying flagpoles and other elongate items quickly, safely, and efficiently to flagpole holders and other brackets mounted to buildings, utility poles, or other structures. Since mounted flagpole holders and brackets are predominantly utilized in public and private spaces throughout the United States and internationally, the responsibility of hanging flags (or other items) falls to either the private property owner or a public works department. The most common solution to this problem is for a property owner or public works technician (an “installer”) to align a ladder with the mounted holder/bracket, carry the flagpole (with the flag attached) up the ladder, and manually place the flagpole within the flagpole holder or bracket. The drawbacks of such a method are many-fold. For example, this method is labor intensive, as the installer must carry the large ladder wherever flags or other items are to be displayed. In addition, the installer runs the risk of falling from the ladder, even if aided by a helper or second installer. Moreover, a large vehicle must be utilized to move the ladder, or the installer must utilize a bucket truck for large jobs, which disrupts traffic, heightens environmental impact, and raises capital equipment costs to an unacceptable level.

A solution has long been sought for the safe and efficient securing, mounting, installation, and display of flags or other items. Some devices and methods utilizing various techniques have been previously disclosed, including those described in U.S. Pat. Nos. 6,883,459; 8,291,852; and 9,852,668. These patents disclose a variety of combinations and configurations for display or mounting devices and techniques, but none provides a satisfactory solution. These devices fail to suitably account for the presence of mounted flagpole brackets, portability of the device, ease of operator use, and environmental impact. In one embodiment, the present disclosure provides a portable device adapted for effective securing and deployment of a wide variety of elongate items, particularly flagpoles into mounted flagpole holders, in a safe and environmentally acceptable manner. The present disclosure further provides securing devices for removal of items, holding items in place, or assisting in the completion of a task.

### SUMMARY OF THE INVENTION

It is therefore a primary object, feature, and/or advantage of the present invention to provide an improved securing device and methods of use thereof that overcome deficiencies in the prior art.

It is another object, feature, and/or advantage of the present invention to provide a portable unit that deploys, secures, or manipulates elongate items at a height greater than five feet without the use of a ladder.

It is another object, feature, and/or advantage of the present invention to provide a device for the installation and removal of flagpoles or other elongate items that enhances safety for users and reduces traffic disruptions associated with using trucks, bucket trucks, or ladders to hang flags or other items.

It is another object, feature, and/or advantage of the present invention to provide a securing device for flagpoles or other items that utilizes either a fixed-length pole or an extension pole that is modifiable in length.

It is another object, feature, and/or advantage of the present invention to provide a securing device for flagpoles or other items that utilizes a modular extension pole, where discrete pieces (or modules) may be utilized to provide for a host of lengths, shapes, and/or geometries.

It is another object, feature, and/or advantage of the present invention to provide a securing device for flagpoles or other items that is preferably about 10 feet in total length but may be between 5 feet and 30 feet in total length.

It is another object, feature, and/or advantage of the present invention to provide a securing device for flagpoles or other items that includes a loading zone that allows an operator to removably place a flagpole within the securing device.

It is another object, feature, and/or advantage of the present invention to provide a securing device for flagpoles or other items that includes an actuating sliding member biased toward the top of the device that allows for the removable placement of a flagpole within the loading zone of the securing device via actuation of the sliding member.

It is another object, feature, and/or advantage of the present invention to provide a device that includes a sliding member biased toward the top of the device by a spring or the like so that an operator holding the device may actuate the sliding member, allowing for the placement of a flagpole or other item within the loading zone of the device, and once the flagpole or other item is inside the loading zone, the operator may release the sliding member, which then holds the flagpole or other item in the device under tension.

It is another object, feature, and/or advantage of the present invention to provide a securing device for flagpoles or other items that includes a guide member associated with the top of the device so that an operator may easily align and/or orient the securing device with a flagpole holder or bracket.

It is another object, feature, and/or advantage of the present invention to provide a securing device that includes a reinforcing member associated with a loading zone of the device to enhance the device's structural integrity.

It is another object, feature, and/or advantage of the present invention to provide a device that may be attached to a cart, wagon, or trolley having wheels for enhanced portability.

It is another object, feature, and/or advantage of the present invention to provide a securing device that may be used for many different purposes, including but not limited to the placement or installation of flags, the securing of tree branches during pruning or cutting, or the securing of a hose for gutter cleaning applications.

These and/or other objects, features, and advantages of the present invention will be apparent to those skilled in the art. The present invention is not to be limited to or by these objects, features and advantages, and no single embodiment need exhibit every object, feature, and/or advantage.

### BRIEF DESCRIPTION OF THE DRAWINGS

FIG. 1 is a perspective view of a first embodiment of a securing device where an elongate item is secured by a sliding member.

FIG. 2 is a second perspective view of a grabber portion of the securing device shown in FIG. 1, where the sliding member is actuated and the securing device is in an open configuration.

FIG. 3 is a top view of the grabber portion of securing device shown in FIG. 2.

FIG. 4 is a first side view of the grabber portion of securing device shown in FIG. 2.

FIG. 5 is front view of the grabber portion of securing device shown in FIG. 2.

FIG. 6 is a second side view of the grabber portion of securing device shown in FIG. 2 opposite the view shown in FIG. 4.

FIG. 7 is a rear view of the grabber portion of securing device shown in FIG. 2.

FIG. 8 is a bottom view of the grabber portion of securing device shown in FIG. 2.

### DETAILED DESCRIPTION OF EXEMPLARY EMBODIMENTS

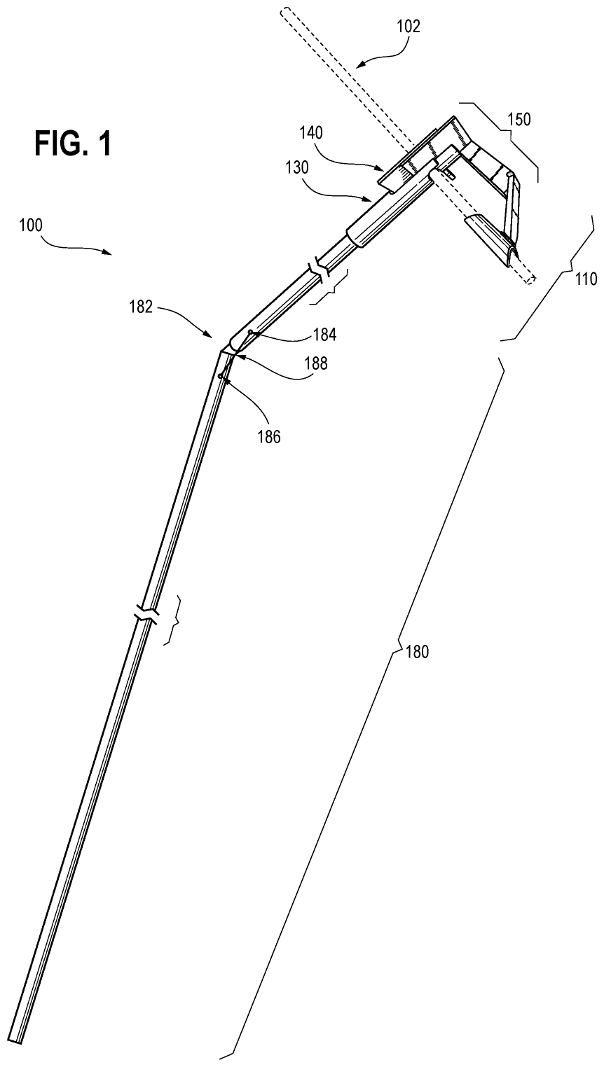

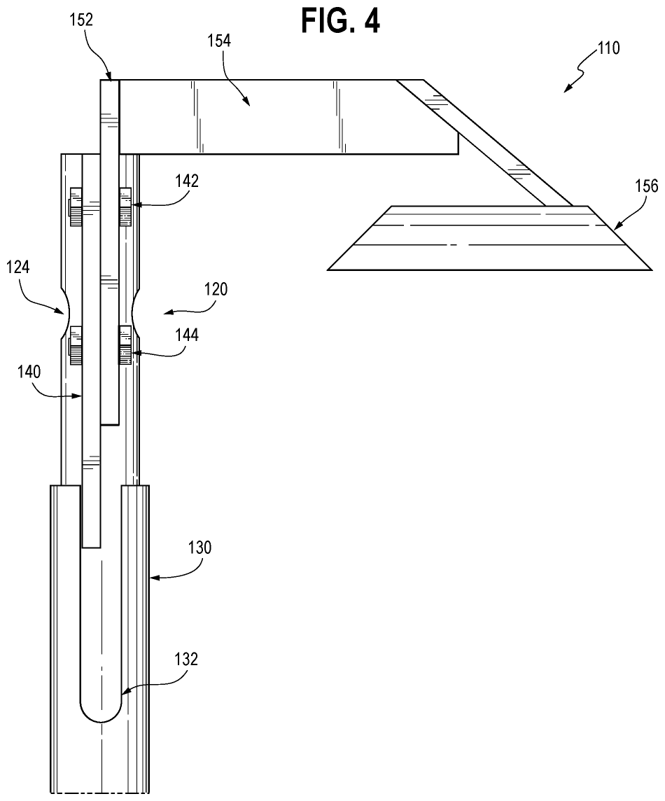

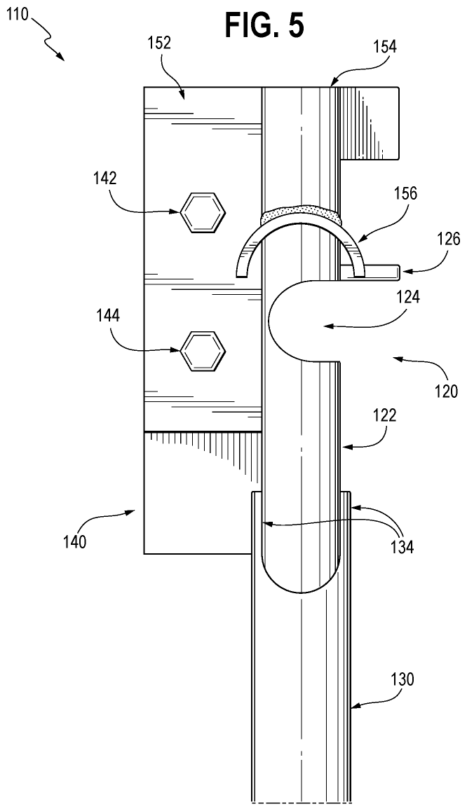

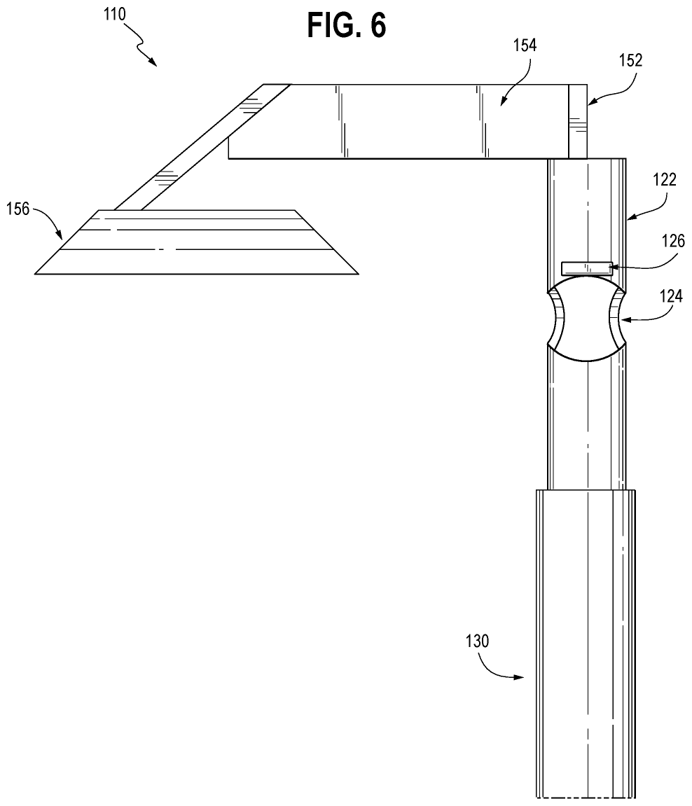

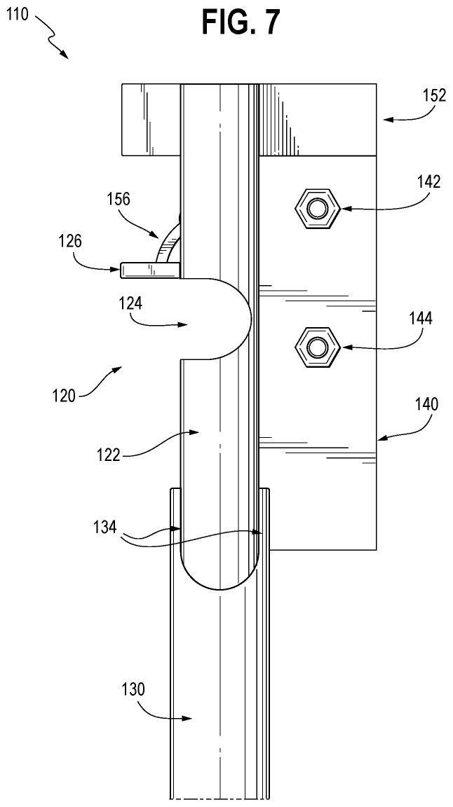

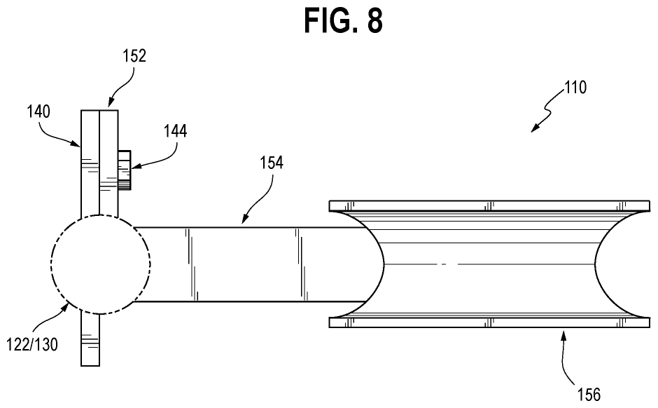

Referring now to the drawings wherein like numerals refer to like parts, FIGS. 1-8 are perspective views of a first embodiment of securing device 100. Securing device 100 is a portable, self-contained unit that allows an operator to install or deploy elongate members, e.g., flagpoles or decorations, for display on buildings or other structures. Securing device 100 may generally include a grabber portion 110 and an extension portion 180.

FIG. 1 shows an exemplary embodiment of securing device 100. Grabber portion 110 secures elongate items (such as flagpole 102) using a loading zone 120 and sliding member 130 under tension. The securing device 100 may be fabricated from aluminum, galvanized steel, stainless steel, iron, high-strength polymer or the like. The material employed should be strong enough to withstand heavy usage, but light enough in application to allow a single user to lift and operate securing device 100. Preferably, securing device 100 is fabricated using aluminum (e.g., schedule 40 aluminum tube), and individual pieces may be adjoined via welding. Securing device 100 may include reinforcing member 140 adjacent loading zone 120 to provide additional structural support to grabber portion 110 of securing device 100.

Extension portion 180 may be a fixed-length single pole, a fixed-length pole comprising multiple pieces, an extension pole that is modifiable in length, or the like. One example of an extension pole that is modifiable in length is a telescoping pole. Extension portion 180 may also take on a variety of geometries. In some embodiments, extension portion 180 may be straight along its length running from the bottom of securing device 100 to grabber portion 110. In other embodiments, such as the embodiment illustrated in FIG. 1, extension portion 180 may have a single bend 182 along its length. Bend 182 may be any angle between zero and 90 degrees, but it has been determined that a bend of about 22 degrees is preferred. Alternatively or additionally, bend 182 may be the result of a pivotal connection, where the angle may be determined, set, and modified by an operator.

Extension portion 180 may also include eyelets 184, 186 for allowing a cable 188 therethrough. Cable 188 is attached to sliding member 130 at grabber portion 110 and is available for an operator to pull in order to actuate sliding member 130. Cable 188 may be placed with securing device 100 and travel through an interior of extension portion 180. Alternatively, cable 188 may hang freely from sliding member 130. It is preferred for cable to run either within the length of extension portion 180 or on the exterior, alongside extension portion 180. In embodiments where cable 188 runs on the exterior of extension portion 180, a handle may be attached to the end of cable 188. The handle may be fastened or otherwise removably attached to extension portion 180 by a projecting ring or collar, a clip, a flange, magnets, or the like. This allows an operator to keep cable 188 clear of the working area during use of securing device 100.

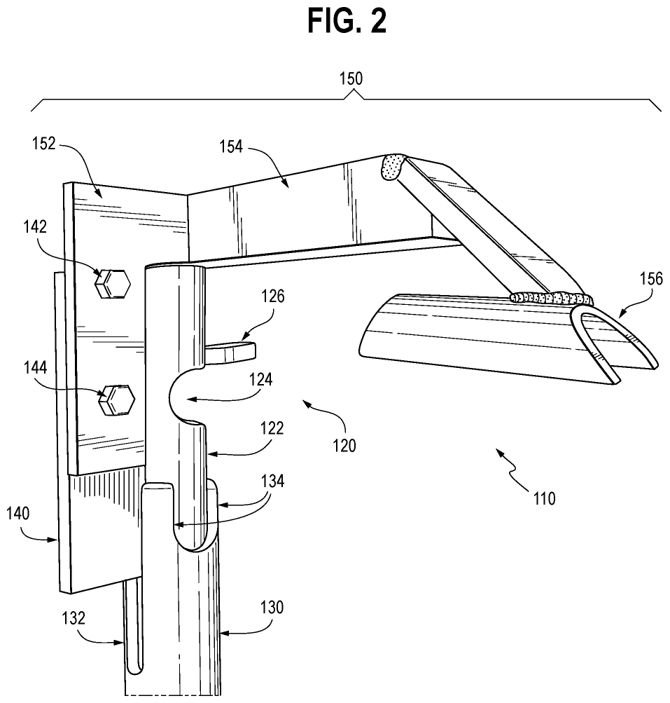

FIG. 2 is a perspective view of grabber portion 110 of securing device 100. In this embodiment, grabber portion 110 includes loading zone 120, sliding member 130, reinforcing member 140, and guide 150. Loading zone 120 generally comprises a core 122, where a portion of core 122 has been hollowed out or otherwise removed to allow for the loading of a flagpole or other elongate item, illustrated as u-shaped section 124. Alternatively, core 122 could be fabricated in the configuration shown in FIG. 2. For instance, core 122 could be fabricated or manufactured as a hollow tube including a u-shaped section 124. Loading zone 120 may also include a flange 126. Optional flange 126 allows an operator to urge a flagpole or other elongate item quickly and efficiently into u-shaped section 124 of loading zone 120 during use. Flange 126 may be formed by cutting and bending a portion of core 122, forming core 122 with flange 126 (e.g., by molding), or by attachment of flange 126 to core 122 (e.g., by welding).

Sliding member 130 generally comprises a tube that is sized with an inner diameter large enough to slidably engage the exterior of core 122. In certain embodiments, sliding member 130 may also include slot 132 and tabs 134, 136. Slot 132 accommodates the presence of reinforcing member 140, while also allowing sliding member 130 to slide or move along the length of core 122. Tabs 134, 136 provide closure to u-shaped section 124 of loading zone 120 when sliding member 130 is in its unactuated state. When sliding member 130 is in an unactuated state, grabber portion 110 is in a closed configuration (as shown in FIG. 1). In FIG. 2, sliding member 130 is shown in its actuated state and grabber portion 110 is in an open configuration to allow for the placement of a flagpole or other elongate item within loading zone 120.

Reinforcing member 140 is shown in FIG. 2 as a projection attached to core 122. Reinforcing member 140 reinforces and provides enhanced structural integrity to grabber portion 110. In some embodiments, reinforcing member 140 provides enhanced structural integrity to core 122 in the area of u-shaped section 124. Reinforcing member 140 may generally be a piece of strong, durable material such as aluminum, steel, polymer, or the like. While this invention contemplates the use of many different materials as reinforcing member 140, aluminum flat stock is preferred (e.g., a flat piece of ¼ inch thickness). Although reinforcing member 140 is illustrated as a piece of flat stock welded to core 122, it should be understood that reinforcing member 140 could be molded, forged, or otherwise produced as a single piece along with core 122.

In the embodiment shown in FIG. 2, reinforcing member 140 also includes holes for bolts 142, 144. Bolts 142, 144 may serve multiple functions. For instance, bolts 142, 144 may be utilized to removably attach guide 150 to securing device 100. In addition or alternatively, bolts 142, 144 may be utilized to mount springs to hold sliding member 130 under tension while in an unactuated state. However, it should be understood by those of skill in the art that bolts 142, 144 are illustrated as fasteners to attach and steady guide 150. As such, any type of fastener or removable attachment to reinforcing member 140 may be utilized in conjunction with guide 150, and this disclosure is not limited to a reinforcing member 140 with holes for bolts 142, 144. In addition, springs used to bias sliding member 130 toward u-shaped section 124 of loading zone 120 may be attached to grabber portion 110 (such as core 122) at any point, and are not limited to attachment at bolts 142, 144 of reinforcing member 140. It should be further understood that alternatives to springs may be utilized for securing device 100. For instance, pneumatic or hydraulic systems may be incorporated. Memory material, such as metal, foam, or polymer may also be employed.

Guide 150 is shown in FIG. 2 as a removable component of grabber portion 110. Guide 150 generally aids an operator of securing device 100 in guiding a flagpole or other elongate item into a mounted flagpole holder or bracket. In the embodiment of FIG. 2, guide 150 comprises an attachment flange 152, extension arm 154, and receiver 156. Attachment flange 152 removably attaches to reinforcing member 140 via fasteners (depicted as bolts 142, 144). In other embodiments, attachment flange 152 could be coextensive with or permanently affixed to reinforcing member 140 or core 122. Extension arm 154 extends receiver 156 away from the body of grabber portion 110, toward a site of installation. Receiver 156 interacts with an installation site by allowing an operator to align and guide grabber portion 110 with at least a portion of a mounted bracket, flagpole holder, or the like. In the embodiment of FIG. 2, receiver 156 is a pipe that has been cut in half lengthwise to create a trough-shaped piece, which allows for interaction with most mounted brackets. Guide 150 provides an aid for and allows alignment, placement, and installation of a flagpole or other elongate item in an intended installation site.

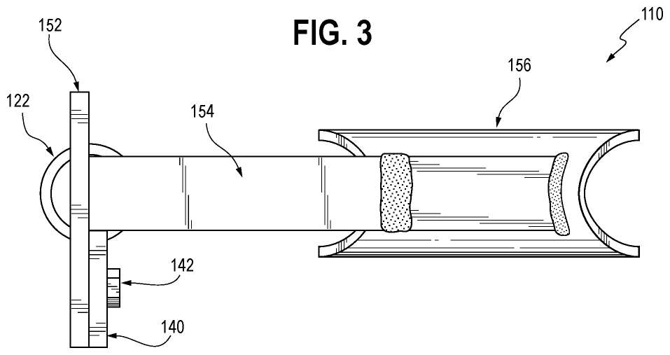

FIGS. 3-8 include additional views of various portions of the embodiment of FIG. 1.

In operation, a user prepares a flagpole or other elongate item to be installed via use of securing device 100. The user holds securing device 100 at extension portion 180 and pulls cable 188 to actuate sliding member 130 and provide access to loading zone 120. The user then orients securing device 100 so that the flagpole or other elongate item is within loading zone 120, optionally by use of flange 126. Operator then releases cable 188, allowing sliding member 130 to return to its unactuated state, biased toward the top of grabber portion 110. The flagpole or other elongate item is now stable within loading zone 120 of securing device 100. The user then, optionally using guide 150, may align securing device 100 with a target installation site. Once the flagpole or other elongate item is aligned with the target installation site, the user may pull cable 188, which retracts sliding member 130 and opens loading zone 120 via u-shaped section 124. The flagpole or other elongate item is freed from loading zone 120, the user releases cable 188, and securing device returns to its original state and is ready for re-use.

In another method of operation, a user may secure a tool or other implement to securing device 100 for completion of a task. For instance, an operator may use securing device 100 to clean gutters by the placement and securing of a hose in loading zone 120. The user holds securing device 100 at extension portion 180 and pulls cable 188 to actuate sliding member 130 and provide access to loading zone 120. The user then orients securing device 100 so that a hose is within loading zone 120. Operator then releases cable 188, allowing sliding member 130 to return to its unactuated state, biased toward the top of grabber portion 110. The hose is now stable within loading zone 120 of securing device 100. The user may then align securing device 100 with a target, such as a gutter in need of cleaning. Once the hose is aligned with the target site, the user may turn on a water supply to the hose and blast dirt and debris out of the gutter via the water pressure of the hose. When the gutter cleaning is complete, the user may pull cable 188, which retracts sliding member 130 and opens loading zone 120 via u-shaped section 124. The hose is then freed from loading zone 120, the user releases cable 188, and securing device returns to its original state and is ready for re-use.

In yet another method of operation, securing device 100 may be used for safely gripping and removing items or debris in high places. For instance, an operator may use securing device 100 during tree pruning to remove pruned tree branches by the placement of a branch to be pruned within loading zone 120. The user holds securing device 100 at extension portion 180 and pulls cable 188 to actuate sliding member 130 and provide access to loading zone 120. The user then orients securing device 100 so that a branch to be pruned is within loading zone 120. Operator then releases cable 188, allowing sliding member 130 to return to its unactuated state, biased toward the top of grabber portion 110. The branch to be pruned is now stable within loading zone 120 of securing device 100. The user may then prunes the branch, freeing it from the tree. Once the user moves securing device 100 to a safe location, the user may pull cable 188, which retracts sliding member 130 and opens loading zone 120 via u-shaped section 124. The pruned branch is then freed from loading zone 120, the user releases cable 188, and securing device returns to its original state and is ready for re-use.

A method for making a securing device is provided below. The method includes providing a core for grabber portion by forming a u-shaped section in a tubular member, such as 1-inch schedule 40 aluminum tube, having an outer diameter of about 1.32 inches. A flange may be formed with or attached to the core adjacent the u-shaped section. A reinforcing member, such as a piece of ¼-inch aluminum flat stock or the like, may be attached to the core, preferably by welding. Alternatively, the core and reinforcing member (and optional flange) may be formed as one piece, as described above.

A sliding member is made by forming or providing at least a portion of a cylinder. The cylinder may be a length of 1¼-inch schedule 40 aluminum tubing having and inner diameter of about 1.38 inches. Sliding member may be between 3 and 36 inches in length, but a sliding member of around 6-18 inches is preferred. The inner diameter of the sliding member should be slightly larger than the outer diameter of the core. Once the dimensions of the sliding member are set, a slot and tab may be formed on the sliding member. The sliding member is placed over the core, such that the reinforcing member is within the sliding member's slot, and at least one of the sliding member's tabs covers the u-shaped section of the core. A cable is attached to the sliding member and either runs through the inside of the core, to the exterior of the sliding member, or is allowed to hang freely from the sliding member. One or more springs having a first end and second end are attached to the sliding member at the first end and anchored to the reinforcing member or core at the second end such that the one or more springs are under tension while sliding member is at rest.

An extension portion may be attached to or coextensive with the core. Optionally, a bend between zero and 90 degrees may be formed in extension portion as described above. An optional guide may be made by providing or forming an attachment flange e.g., from metal or polymer flat stock. An extension arm may be formed with, affixed, or otherwise connected to the attachment flange, and a receiver may be formed with, affixed, or otherwise connected to the extension arm. The receiver may be made by bending flat stock to a desired configuration, preferably one that compliments the installation site of standard flagpole holders or mounted brackets. Alternatively, the receiver may be formed by cutting out a portion of a tubular member, such as a three-inch section of 1¼-inch schedule 40 aluminum tube, and then halving the tube to provide the shape of receiver 156 shown in FIGS. 1-8. The optional guide may then be attached to the reinforcing member using fasteners, such as bolts. When the guide is attached to the securing device, it should be aligned such that the receiver is aligned with a boundary of a loading zone, such as the top of the u-shaped section.

Most of the components of securing device 100 may be formed by any known manufacturing process for metal parts, such as machining, molding, welding, pressing, injection molding, CNC machining, 3-D printing, or the like.

In all embodiments, securing device 100 may have one or more handles associated with extension portion 180 that allows a user to comfortably hold and use the device. For instance, a single handle grip may be utilized on extension portion 180 where an operator holds the device to enhance grip or comfort. A second handle may be a side handle attached to and extending at a right angle from extension portion 180 to enhance device maneuverability. Such a side handle may be those found on the market manufactured by DeWalt or Milwaukee Tool, however a side handle may also be fabricated to fold and lay parallel to extension portion 180 while not in use. Alternatively or additionally, extension portion 180 of securing device 100 may include a trigger or automated actuation mechanism for actuating sliding member 130. Extension portion 180 may alternatively or additionally include an interface, driveshaft, and/or a transmission (e.g., chain, gears, or the like) allowing for the attachment of a tool (e.g., a rotary power tool) and/or the actuation of sliding member 130.

Furthermore, extension portion 180 may be modular. As a non-limiting example, extension portion 180 may have a total length of 10 feet. To increase portability of the device, extension portion 180 may be divided into 3 sections equivalent in length. Each section may be attached via threaded couplings at their ends, via a quick-release mechanism such as retractable pins, via welded couplings, and/or via fasteners (such as bolts or screws). In addition, a coupling incorporating bends of various angles may be utilized in such a modular system. For instance, if a user requires around a 7-foot extension with a 22-degree bend, the invention provides for two sections of extension tube three-feet in length and one coupling with a 22-degree bend (of about 12 inches in length) that are assembled in the field via threads, quick-release, fasteners, or the like and attached to grabber portion 110 for use.

In another embodiment, securing device 100 may have an overall length of 10 feet, where grabber portion 110 is six feet long and incorporates a coupling for an extension pole, and the extension pole provides about another four feet of overall length. In this embodiment, core 122 would extend about two to four feet past sliding member 130 (and may include an angle or bend). The core may have the coupling for an extension pole attached to its bottom end via welding or other forms of attachment. The coupling for an extension pole may comprise a 6-inch to 24-inch length of 1¼-inch schedule 40 aluminum tube welded to the core's bottom or terminal end. The coupling for the extension pole may further include holes, pins, or other anchors on its end opposite the core, which may be used for attachment of the extension pole (e.g., a length of 1-inch schedule 40 aluminum tube). It is preferred for the length of the extension pole to be about four feet, but any length suitable for mounting flagpoles or other elongate items may be employed.

It should be noted that in all embodiments including a loading zone or core, the portion referred to herein as a “u-shaped section” or u-shaped section 124 is not limited to a u-shape. For instance, such a section could easily be described as a c-shaped section, a rectangular-shaped section, an open portion, an opening, or a dock. However, it should also be noted that in embodiments of a device used specifically for flagpoles, a u-shaped section or c-shaped section is preferred, as most flagpoles are cylindrical in shape, and a u-shape or c-shape compliments the profile of the item to be installed. Utilizing such a complimentary profile for loading zone provides certain advantages, such as increased ease of placing the item within the loading zone and increased stability when the installation device is loaded.

The disclosed embodiments have many attendant advantages. As a first example, the installation device of the present invention provides an efficient solution for mounting or placing flagpoles, decorations, or other items without the use of a ladder or bucket truck in a city or municipality with mounted flagpole holders or brackets. As a second example, the guides utilized in various embodiments of the invention provide enhanced ease and comfort of use to operators. As a third example, the embodiments of the invention provide decreased environmental impact by providing a solution that does not require the use of high-powered trucks or devices burning fossil fuels. As a fourth example, various embodiments of the securing device allow for gripping and utilization of tools in high places, such as a hose for gutter cleaning. As a fifth example, various embodiments of the securing device allow for safe gripping and removal of items or debris in high places, such as pruned tree branches.

It should be understood that various changes and modifications to the presently disclosed embodiments described herein will be apparent to those skilled in the art. Such changes and modifications may be made without departing from the spirit and scope of the present inventions and without diminishing their attendant advantages. It is, therefore, intended that such changes and modifications be covered by any prospective claims concerning this disclosure.

The invention is claimed as follows:

1. An apparatus comprising:
a grabber portion having a loading zone and a sliding member;
an actuator connected to the sliding member;
an extension portion comprising a pole; and
a guide removably attached to the grabber portion;
wherein the sliding member is biased toward the loading zone in an unactuated state, and
the actuator is configured to move the sliding member so that the loading zone is open to receive an elongate item while the sliding member is in an actuated state.

2. The apparatus of claim 1, wherein the actuator comprises a cable or string.

3. The apparatus of claim 2, wherein the sliding member is biased toward the loading zone by one or more springs.

4. The apparatus of claim 3, wherein the loading zone comprises a u-shaped section and the sliding member comprises a tab portion.

5. The apparatus of claim 4, wherein the tab portion substantially covers the u-shaped section when the sliding member is in an unactuated state.

6. The apparatus of claim 5, wherein the sliding member comprises a proximal end and a distal end; wherein the tab is associated with the distal end; and wherein the actuator is connected to the proximal end.

7. The apparatus of claim 6, wherein the cable or string runs through an interior of extension portion.

8. The apparatus of claim 2, wherein the guide comprises an extension arm and a receiver.

9. The apparatus of claim 6, wherein the receiver comprises a halved-pipe.

10. A device for securing an elongate item comprising:
a grabber portion having a loading zone and a sliding member;
an actuator connected to the sliding member;
an extension portion comprising a pole; and
a reinforcing member connected to the loading zone;
wherein the sliding member is biased toward the loading zone in an unactuated state, and the actuator is configured to move the sliding member so that the loading zone is open to receive the elongate item while the sliding member is in an actuated state.

11. The device of claim 10, further comprising a guide removably attached to the device.

12. The device of claim 11, wherein the guide is removably attached to the grabber portion and the guide comprises an extension arm and a receiver.

13. The device of claim 10, wherein the loading zone comprises a u-shaped section and the sliding member comprises a tab portion.

14. The device of claim 13, wherein the tab portion substantially covers the u-shaped section when the sliding member is in an unactuated state.

15. The device of claim 14, wherein the reinforcing member provides enhanced structural integrity to the u-shaped section of the grabber portion.

16. The device of claim 15, wherein the reinforcing member comprises a piece of flat stock adjacent the loading zone.

17. The device of claim 15, further comprising a guide removably attached to the device;
wherein the guide is removably attached to the grabber portion and the guide comprises an attachment flange, an extension arm, and a receiver.

18. The device of claim 17, wherein the attachment flange of the guide is removably attached to the reinforcing member.

19. The device of claim 15, wherein the actuator comprises a cable or string.

20. The device of claim 19, wherein the cable or string runs through an interior of extension portion.
